(19) United States
(12) Patent Application Publication
(10) Pub. No.: US 2010/0177598 A1
(43) Pub. Date: Jul. 15, 2010

(54) Methods and Apparatuses for a Network Enabled Alarm Clock

(75) Inventors: Yusheng Zhang, San Jose, CA (US); Qi Cao, Milpitas, CA (US); Lawrence Mok, San Leandro, CA (US); Michael Yip, Los Altos, CA (US); DongLi Li, Shanghai (CN)

Correspondence Address: Venture Pacific Law, PC, 5201 Great America Parkway, Suite 270, Santa Clara, CA, 95054, US

(73) Assignee: AMLOGIC CO., LTD., Santa Clara, CA (US)

(21) Appl. No.: 12/684,104

(22) Filed: Jan. 7, 2010

Related U.S. Application Data
(60) Provisional application No. 61/143,156, filed on Jan. 7, 2009.

(51) Int. Cl. G04G 13/02; G04B 47/00

(52) U.S. Cl. 368/10

(57) ABSTRACT

An electronic alarm clock connected to one or more networks comprises: a network communications device, wherein the network device receives content from the networks; a touch screen; one or more speakers; and a local storage device, wherein a clock function is provided, wherein an alarm function is provided that plays user specified content at a user specified time on said screen and the speakers, and wherein a physical button is disposed on the clock to manage the alarm function during an alarm.

### CROSS REFERENCE

This application claims priority from a provisional patent application entitled “Methods and Apparatuses for a Network Enabled Alarm Clock” filed on Jan. 7, 2009 and having an Application No. 61/143,156. Said application is incorporated herein by reference.

### FIELD OF INVENTION

This invention relates to methods and apparatuses for an alarm clock and, in particular to, methods and apparatuses for an alarm clock that is network enabled and can play multimedia content.

### BACKGROUND

Traditionally, alarm clocks provide useful functions, including an alarm function to alert a user at a specified time of day, displaying a time of day, and receiving and playing radio broadcasts via frequency modulated (“FM”) signals and via amplitude modulated (“AM”) signals. Some alarm clocks offer other advanced features, including the capability to play compact discs and the capability to play mp3's stored on a local storage device.

However, traditional alarm clocks lack sophisticated functionality and convenience desired by the public. For instance, alarm clocks are limited to a number of physical buttons on the clocks to manually adjust and set alarms and to input commands to the clocks. These alarm clocks do not offer an easy and convenient user interface to manage the functionality of an alarm clock.

With respect to an alarm for alarm clocks, an alarm plays recorded beeping sounds or plays a radio station when the alarm is activated. These alarms lack the capability to play customized content for the alarm. Furthermore, traditional alarm clocks lack the ability to access and utilize the ever increasing content provided via a network (e.g. content provided via the Internet).

Therefore, it is desirable to provide a network enabled alarm clock that can receive information via a network (e.g. the Internet) and can use that content to customize the content used by that alarm clock.

### SUMMARY OF INVENTION

An object of this invention is to provide an alarm clock that can receive content (e.g. emails, videos, images, and other content) from a network.

Another object of this invention is to provide an alarm clock, where content can be specified to be played during an alarm.

Yet another object of this invention is to provide an alarm clock, which can be remotely managed.

Yet a further object of this invention is to provide an alarm clock, which can automatically synchronize its time with another clock via a network or over the air broadcast.

And yet a further object of this invention is to provide an alarm clock, which can be used to manage other devices that are remote from the alarm clock via a network.

Briefly, an electronic alarm clock connected to one or more networks, comprising: a network communications device, wherein said network device receives content from said networks; a touch screen; one or more speakers; and a local storage device, wherein a clock function is provided, wherein an alarm function is provided that plays user specified content at a user specified time on said screen and said speakers, and wherein a physical button is disposed on said clock to manage the alarm function during an alarm.

An advantage of this invention is that an alarm clock is provided that can receive content (e.g. emails, videos, images, and other content) from a network.

Another advantage of this invention is that an alarm clock is provided, where content can be specified to be played during an alarm of the alarm clock.

Yet another advantage of this invention is that an alarm clock is provided, which can be remotely managed.

Yet a further advantage of this invention is that an alarm clock is provided, which can automatically synchronize its time with another clock via a network or over the air broadcast.

And yet a further advantage of this invention is that an alarm clock is provided, which can be used to manage other devices that are remote from the alarm clock via a network.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1a illustrates the results of a network enabled alarm clock displaying a time of day.

FIG. 1b illustrates the results of a network enabled alarm clock displaying a navigation menu used for managing the network enabled alarm clock.

FIG. 2 illustrates a system of the present invention, where an alarm clock is connected to various content providers via a network.

FIG. 3 illustrates a system of the present invention, where a network enabled alarm clock is connected to various devices via a home network.

### DETAILED DESCRIPTION OF THE PREFERRED EMBODIMENTS

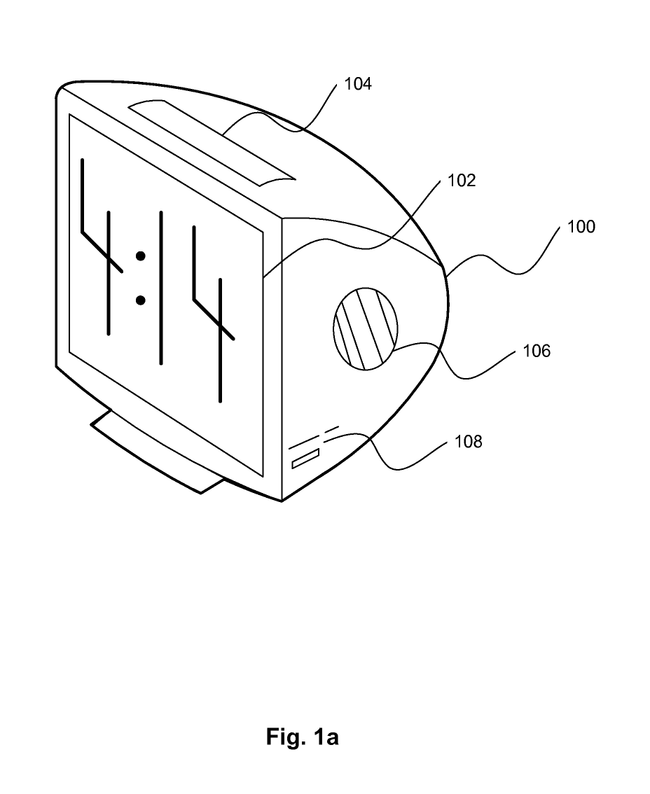

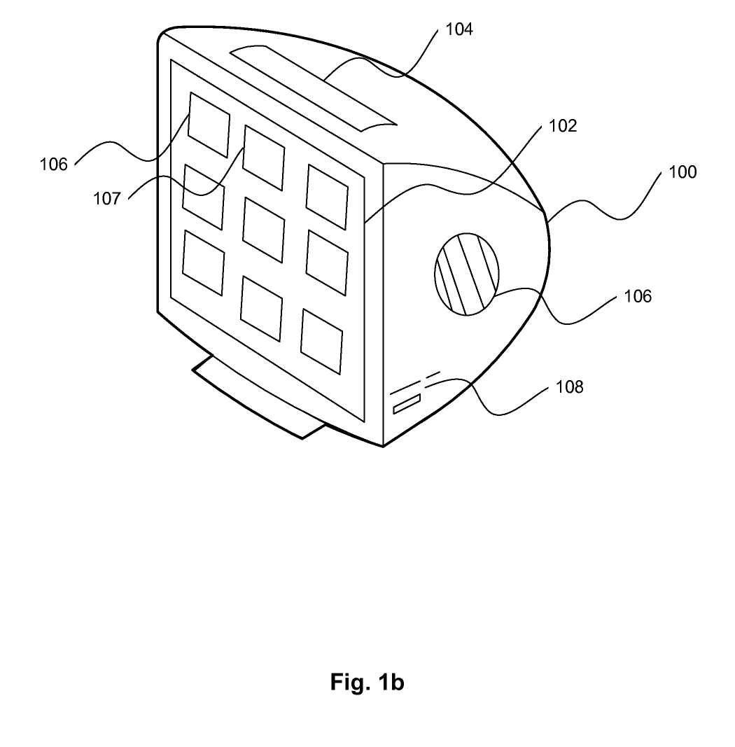

FIG. 1a illustrates an embodiment of a network enabled alarm clock of the present invention, herein referred to as an alarm clock, displaying a time of day. An alarm clock 100 can comprise: a touch screen 102; a button 104; one or more speakers 106; one or more connective capabilities (e.g. nonvolatile memory card reader, USB connector, or other connective capability) 108; a power supply (not shown); and one or more receivers (not shown) to receive FM signals, AM signals, television signals, cellular signals, 802.11 signals, Bluetooth signals, or any other communications signals.

The touch screen 102 can be used to display a time, a user interface, an image, a video, a webpage, multimedia content, or other images. The touch screen can also be used by a user to input commands to the user interface, and to manage the other functionalities of the network enabled alarm clock. The displayed time can be set using the touch screen. The time can also be automatically synchronized with another clock via a network or over the air broadcast.

The button 104 can be used as what is traditionally referred to as a “snooze” button. Similarly to a traditional snooze button, this button can turn off an alarm for a predefined amount of time. Furthermore, the snooze button can be used for additional functionality based upon the number of times the snooze button is pressed in succession within a specified period of time (e.g. within five seconds of the first time the button is pressed), the length of each button pressed, or a combination of the number of times the button is pressed within a specified period of time and the relative length each time the button is held down.

For instance, when an alarm turns on, the snooze button can be pressed once to turn off the alarm for a predefined amount of time (e.g. 5 minutes). If the snooze button is pressed twice within a predefined amount of time (e.g. 5 seconds), then the alarm may be turned off for a predefined amount of time (e.g. 10 minutes). If the snooze button is pressed three times within a predefined amount of time (e.g. 5 seconds), then the alarm may be turned off until the user turns it back on or a next alarm turns on.

Another example can take into account the amount of time the snooze button is pressed down. For instance, if the snooze button is pressed down for a predefined amount of time (e.g. 5 seconds), then the volume of the alarm can decrease by half. The longer the snooze button is held down, the more the volume of the alarm will be decreased. The volume can be decreased proportionally, exponentially, or in other factors in relation to the amount of time the snooze button is held down.

It will be appreciated that the snooze button can be a multifunctional button that can be implemented in software or physically implemented in hardware. Furthermore, the snooze button can also be used to scroll through various navigation menus of the network enabled alarm clock. The snooze button's functionality is not exclusive to the alarm function of the alarm clock. For instance, the snooze button can be used to navigate a menu. With respect to a navigation menu of the user interface, the snooze button can be pressed to cycle through the various submenus and items. When a desired menu or item is reached, the snooze button can be pressed for a specified amount of time to select that menu or item. Alternatively, a predefined number of taps of the snooze button can be used to select a specific desired menu or item.

The alarm clock 100 can also have various connective capabilities 108. An alarm clock's connective capabilities may refer to the capability of the alarm clock to download content through a variety of technologies, such as through the Internet via a wired broadband connection, a wireless broadband connection, a telephone connection, or a satellite connection, a multimedia card reader, a universal serial bus (“USB”) connection, and other types of connections. These connective capabilities may be physically integrated, in whole or in part, with the alarm clock or may be, in whole or in part, implemented in a physically separate unit that is connected to the alarm clock. In the preferred embodiments, a Wi-Fi connection or other wireless connection may be used.

The alarm clock 100 can have various power sources to supply power to the alarm clock. The alarm clock may have a storage area to insert primary batteries and/or secondary batteries into the alarm clock. The alarm clock can also be powered via an external alternating current (“a/c”) power supply or an external direct current (“dc”) power supply.

The alarm clock 100 may have one or more speakers physically integrated in the alarm clock to play sounds for alarms, radio broadcasts, television broadcasts, multimedia content, or other content. Additionally, the alarm clock can connect to remote speakers through its various connective capabilities, or through a dedicated audio output connection.

The alarm clock 100 can comprise of one or more receivers and one more transmitters, including a radio receiver for FM and AM signals, a television receiver for analog and digital signals, an 802.11x receiver and transmitter (e.g. 802.11a, b, g, and other standards which are based on 802.11), a Bluetooth receiver and transmitter, and other signal receivers and transmitters.

FIG. 1b illustrates a network enabled alarm clock of the present invention displaying a navigation menu used for managing the network enabled alarm clock. The alarm clock 100 can display a user interface (“UI”) for a user to manage the user device. This user interface can be a text based UI, a pictorial/icon based UI, or a combination of both (i.e. text based and pictorial/icon based UI). For instance, the UI can comprise of icons 106 and 107, where those icons can display illustrations to symbolize the various items and menus that icon is linked with, including menus to manage a content manager, a personal information manager (“PIM”) software, FM/AM settings, video settings, network settings, alarm settings, sounds settings, image and audio settings, and other settings, menus, or managers. Once the navigation menu is displayed, the user can use the touch screen on the alarm clock to select an icon by pressing the icon on the touch screen. From there, the submenus for that icon can be displayed.

In particular, the content manager can manage the various content stored locally (e.g. via a USB connection, a nonvolatile memory device, an internal storage device of the alarm clock, or other storage devices). The content manager can be programmed to access various IP addresses to download content to be displayed on the alarm clock. The programming of the content manager can be performed locally using the alarm clock or can be performed remotely using a computer connected to the alarm clock.

With respect to selecting content to download, the alarm clock can access any resource located on a network, preferably on the Internet. For instance, a web feed (e.g. RSS feed, podcasts, and other web feed formats) can be inputted into the alarm clock such that an alarm clock can subscribe to a web feed by storing the feed's resource locater (e.g. URI, URL, IP address, or other location means) in the alarm clock's manager. The alarm clock can then regularly check the user's subscribed feeds for new work/content and new publications. When new work or publications are found, it is downloaded to the alarm clock. The downloaded content can be displayed and/or played on the alarm clock at scheduled times. The alarm clock can be programmed to automatically display and play the feeds when new works are found, or it can periodically display the feeds on a user specified schedule.

The alarm clock can also download images from one or more photo sharing sites via a network (e.g. the Internet). The resource location and the login information can be inputted to the alarm clock, such that the software on the alarm clock can access the resource via the network. This information can include the following: the names and/or locations of the one or more photo sharing sites, such as the domain names or the Internet Protocol addresses of the one or more photo sharing sites, the associated user name and user password for each of the one or more photo sharing sites, and a selection of one or more photos from each of the one or more photo sharing sites to add to the selected content. Examples of photo sharing sites are Flickr, Mac Web Gallery, Atpic, Kodak Easy Share Gallery, Photobucket, Picasa, Snapfish, and others photo sharing websites.

One or more video sharing sites can be inputted in a similar manner for downloading content from those sites to the alarm clock. The names and/or locations of the one or more video sharing sites, such as the domain names or the IP addresses of the one or more video sharing sites, the associated user login and user password, if any, for the video sharing site, and one or more videos to add to the selected content, can be inputted to the alarm clock to access these sites. Examples of video sharing sites are YouTube, Veoh, Crunchyroll, and other video sharing sites.

With respect to downloading news items, resource locations of the news items, such as the domain names or IP addresses, can be inputted by a user to download content. The locations may be for a specific news article or contain multiple articles which the alarm clock user can scroll through.

Weather information can be displayed on the alarm clock. An alarm clock user can select one or more geographic locations for which weather information is to be displayed. One or more geographic locations can be identified by zip code, mailing address, city and state, longitude and latitude, by a pointer to a map location, or any other means to identify geographic location to retrieve the associated weather for that location via a network.

Similarly one or more stock quotes can be selected for display on the alarm clock by inputting the associated company name, company stock symbol, or other identifier of the company for each of the selected stock quotes in the download manager.

It will be appreciated that the alarm clock can download content (such as music, video games, flash games, and other content) via a network from a network storage device.

Once specified content has been downloaded, a user can specify when to display the downloaded content on the alarm clock by inputting a date and time for displaying of such content. Alternatively, the alarm clock can have predefined settings to display the content. For instance, a broadcasted video can be downloaded, and then be displayed at a user specified time (e.g. 10 p.m.) every night for a specified amount of time (e.g. 1 hour). Therefore, this allows the user to set up a schedule to view a broadcasted video without having to remember to manually download it every night, and then play it on the alarm clock.

The content manager can also be used to manage content stored locally on the alarm clock. For instance, the content manager can rename files, delete files, move files from one folder to another, and manage other aspects of the stored data on the local storage.

In addition to the various components of an alarm clock, the alarm clock can comprise a web server, such that the web server can be programmed to automatically undertake certain actions. For instance, the web server can be programmed to download certain content every morning.

The user can input personal information into the PIM software to store on the alarm clock's local storage. Personal information can include personal notes/journals, address book, a tasks list, significant calendar dates (e.g. birthdays, anniversaries, and appointments and meetings), reminders, email archives, and other information.

The personal information can be used to set up various alarms based on that personal information. For instance, for every inputted birthday, the alarm clock will display alerts at a predefined amount of time before the actual birthday. The alarm can also display information associated with that birthday such as whose birthday it is and what day the birthday is on. Similarly, the user can setup up other alerts based on inputted information.

The FM and AM settings can also be set via the user interface. The touch screen can be used to set various FM and AM stations in memory for future retrieval.

The video settings can similarly be set up where the user can preset channels for later retrieval. Video content can be provided to an alarm clock via over the air analog signals, over the air digital signals, cable signals, satellite signals, a slingbox, or other means for receiving video content.

The network settings menu can be used to manage the various network connections to the alarm clock via Wi-Fi, Bluetooth, or other connective means.

The alarm settings can be used to set alarms at specified events with specified content. The specified events can be a user specified date and time or can be an event. Events can be triggered by the content manager or the PIM software. For instance, an alarm can be triggered when new content from a subscribed RSS feed is retrieved, or if new images have been downloaded from a network. As already stated, the PIM software can automatically generate alarms based upon personal information stored on the alarm clock. For instance, birthday information inputted into the PIM software can be used to generate alerts for those birthdays.

Once an alarm is specified, the content to be displayed and/or played during the alarm can also be specified. The content can be retrieved from a local storage device, can be downloaded from a network, preferably the Internet, or can be provided by the content manager.

For instance, if an alarm is set to wake up a user, then instead of playing the radio or a beeping sound, the alarm clock can be specified to download and play a podcast that reports on the current traffic conditions. Also, an alarm can also retrieve locally stored content. For instance, a user can set the alarm to play specific music (e.g. Hannah Montana, Jonas Brothers, or other artists) stored on the local storage. It will be appreciated that any user specified content can be used as the means of conveying an alarm to the user during a specified event.

The alarm can also be used to communicate to other devices. For instance, the alarm can send information from the alarm to any devices that are connected to the alarm clock. The alarm clock can send a SMS text message to a user's cellular phone to alert the user of the alarm.

The sound settings can be used to manage various speakers for the alarm clock. Those speakers can be physically integrated into the alarm clock, or can be remote from the alarm clock and be driven by the alarm clock remotely, either by way of a wireless connection or a wired connection. For instance, an alarm clock can be in a parent's room, and the speakers for an alarm can be set to speakers in the child's room, 100 feet away. Or alternatively, the speakers can be connected via a network and be located 1000 miles away.

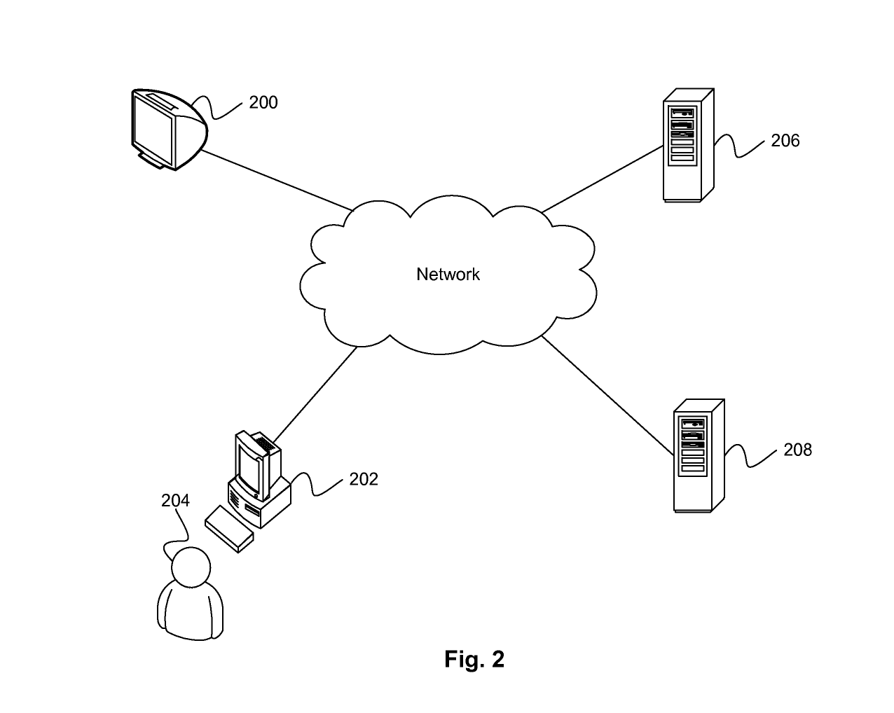

FIG. 2 illustrates a system of the present invention of an alarm clock connected to various content providers via a network. The system can comprise an alarm clock 200, a computer 202, a user 204, and one or more content providers via one or more servers 206 and 208. The user 204 can remotely manage the alarm clock from the computer 202. Additionally, the alarm clock 200 can download content from the content providers 206 and 208. The content providers 206 and 208 can include email servers, video providers, mp3 providers, and so forth.

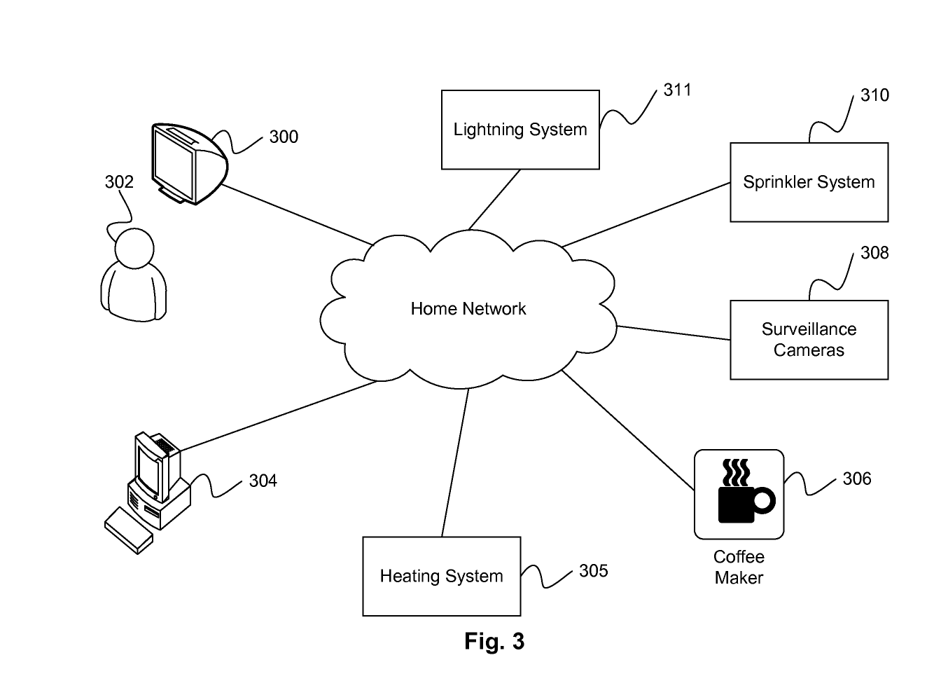

The alarm clock can also control other devices based on the alarm. FIG. 3 illustrates a system of the present invention where a network enabled alarm clock is connected to various devices via a home network. The system comprises a multimedia enabled alarm clock 300, a user 302, a computer 304, a home heating system 305, a coffee machine 306, a home surveillance system 308, a sprinkler system 310, and a lightning system 311.

The alarm clock's alarm function can be used to turn on devices at specified dates and time. For instance, an alarm can be set to turn on the coffee machine 306 at 6 a.m., such that a user can wake up to freshly brewed coffee. The home surveillance system 308 can have different surveillance modes based on the time of day. The homes lightening system 311 can also be set such that the specified lights are turned on during the evening hours and early morning hours, and automatically turned off during the day hours. A home sprinkler system 310 can be set to turn on at a specified time via the alarm clock. Furthermore, the home heating system 305 can be controlled by the alarm clock 300. The alarm clock 300 can set the temperature to a first predefined temperature during the day time, and a second predefined temperature during the night time to conserve energy (or for any other purpose). For instance, in the cold winter months, the heating system 305 may be set at 50 degrees during the day when the home is not occupied, and can be set at 68 degrees during the night when the occupants arrive home.

In an embodiment of the present invention, an alarm clock having a snooze button and wireless Wi-Fi connection is disclosed. Here, the programming of the alarm clock can be performed via a web server. The alarm clock may be programmed with specific RSS feeds, podcasts, internet radio programs, traditional radio stations (e.g., digital, satellite, or AM/FM), video sites (e.g. features of the day), news programming, etc. up to a certain number of programs, where one set of programs may be programmed for the morning hours and a second set of programs may be programmed for the evening hours (e.g. when going to bed). Thus, the user may enjoy time-depending information according to the time of the day.

Furthermore, in one implementation, the snooze button can be programmed such that a double tap (i.e. tapping twice) can scroll through the available modes (e.g. alarm mode to the program-play mode to the select-play mode to the free-program mode to the normal mode, etc.). While in each mode, a single tap can be programmed to scroll through a pre-defined list. For example, in the alarm mode, when the alarm goes off, one tap will provide additional time for sleeping and a double tap will change it to the next mode (e.g. the program-play mode). The alarm mode will play programs depending on the time of the day. In this example, there can be a morning program (user-scrollable through a pre-defined number of programs or auto-scroll and auto-play each program for a pre-defined amount of time (e.g. 2 minutes).

In the program-play mode, the pre-programs can be scrolled through (by a single tap) and the programs can be listened. In the select-program mode, a long list of programs previously entered can be scrolled through, selected, and played. Additionally, a select program can be moved to the alarm mode. In the free-program mode, a small keyboard can be provided on the touch screen where a browser can be directed to fetch web pages and content. In the normal mode, the clock is displayed. In this embodiment, there is only the touch screen, the snooze button, the case encasing the speaker, the circuit board, and the power supply—a minimal number of physical parts. This alarm clock, with portable power and durable (and water-resistant) casing, may be taken from the bedroom to the bathroom. Other than being programmable by using a browser, this alarm clock may be programmed via the touch screen.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. An electronic alarm clock connected to one or more networks, comprising:
a network communications device, wherein said network device receives content from said networks;
a touch screen;
one or more speakers; and
a local storage device,
wherein a clock function is provided, wherein an alarm function is provided that plays user specified content at a user specified time on said screen and said speakers, and wherein a physical button is disposed on said clock to manage the alarm function during an alarm.

2. The electronic alarm clock of claim 1 wherein said user specified content is retrieved from said networks.

3. The electronic alarm clock of claim 1 wherein said user specified content is retrieved from a network storage device.

4. The electronic alarm clock of claim 1 wherein said alarm function is programmed via said touch screen.

5. The electronic alarm clock of claim 1 wherein said alarm function is remotely programmed via said networks.

6. The electronic alarm clock of claim 1 wherein said network communications device supports the reception of one or more of the following: frequency modulated (“FM”) signals, amplitude modulated (“AM”) signals, digital television signals, Wi-Fi signals, Bluetooth signals, and cellular signals.

7. The electronic alarm clock of claim 1 further comprising a battery compartment.

8. The electronic alarm clock of claim 1 wherein said clock function is automatically synchronized with a remote clock via said communications device.

9. The electronic alarm clock of claim 1 wherein said clock provides said alarm to turn on one or more devices connected to said clock via a network.

10. The electronic alarm clock of claim 1 further comprising a web server, wherein the web server can be used to program predefined actions for the clock to perform.

11. The electronic alarm clock of claim 1 wherein the alarms are automatically generated based on user inputted personal information.

12. An electronic alarm clock connected to one or more networks, comprising:
a network communications device, wherein said network device receives content from said networks;
a touch screen;
one or more speakers; and
a local storage device,
wherein a clock function is provided, wherein an alarm function is provided that plays user specified content at a user specified time on said screen and said speakers, wherein a physical button is disposed on said clock to manage the alarm function during an alarm, wherein said user specified content is retrieved from said networks, and wherein said alarm function is programmed via said touch screen.

13. The electronic alarm clock of claim 12 wherein said user specified content is retrieved from a network storage device.

14. The electronic alarm clock of claim 12 wherein said alarm function is remotely programmed via said networks.

15. The electronic alarm clock of claim 12 wherein said network communications device supports the reception of one or more of the following: frequency modulated (“FM”) signals, amplitude modulated (“AM”) signals, digital television signals, Wi-Fi signals, Bluetooth signals, and cellular signals.

16. The electronic alarm clock of claim 12 wherein said clock function is automatically synchronized with a remote clock via said communications device.

17. The electronic alarm clock of claim 12 wherein said clock provides said alarm to turn on one or more devices connected to said clock via a network.

18. The electronic alarm clock of claim 12 further comprising a web server, wherein the web server can be used to program predefined actions for the clock to perform.

19. The electronic alarm clock of claim 12 wherein the alarms are automatically generated based on user inputted personal information.

20. An electronic alarm clock connected to one or more networks, comprising:
a network communications device, wherein said network device receives content from said networks and wherein said network communications device supports the reception of one or more of the following: frequency modulated (“FM”) signals, amplitude modulated (“AM”) signals, digital television signals, Wi-Fi signals, Bluetooth signals, and cellular signals;
a web server, wherein the web server can be used to program predefined actions for the clock to perform;
a touch screen;
one or more speakers; and
a local storage device,
wherein a clock function is provided, wherein an alarm function is provided that plays user specified content at a user specified time on said screen and said speakers, wherein a physical button is disposed on said clock to manage the alarm function during an alarm, wherein said user specified content is retrieved from a network storage device, wherein said alarm function is programmed via said touch screen, wherein said clock function is automatically synchronized with a remote clock via said communications device, wherein said clock provides said alarm to turn on one or more devices connected to said clock via a network, and wherein the alarms are automatically generated based on user inputted personal information.
